(19) United States
(12) Patent Application Publication
(10) Pub. No.: US 2007/0173105 A1
(43) Pub. Date: Jul. 26, 2007

(54) Electrical connector having integral seal seat and strain relief

(76) Inventor: John R. Morello, Warren, OH (US)

Correspondence Address: DELPHI TECHNOLOGIES, INC., M/C 480-410-202, PO BOX 5052, TROY, MI, 48007, US

(21) Appl. No.: 11/340,212

(22) Filed: Jan. 26, 2006

(51) Int. Cl. H01R 13/58

(52) U.S. Cl. 439/449

(57) ABSTRACT

A socket connector having an integral strain relief and seal seat. A connector body has an integral strain relief member composed of a terminal housing, a strain relief, and a seal seat. The seal seat is defined by a seal seat shroud characterized by a left sidewall, a right sidewall, a top wall, a bottom opening opposite the top wall, a terminal housing wall, and a strain relief wall. The strain relief is provided with strain relief openings aligned with terminal cavities of the socket connector. A peripherally ribbed elastomeric seal is sealingly received into the seal seat via the bottom opening, wherein openings of the seal align with the terminal cavities.

### TECHNICAL FIELD

The present invention relates to electrical connectors, and more particularly to an electrical socket connector having an integral seal seat and strain relief with respect to electrical wiring interfaced therewith.

### BACKGROUND OF THE INVENTION

A low profile socket connector having a shroud and a connector lock in which the enlargement for accommodating the connector lock has been eliminated by incorporating a lock arm in the shroud itself has been disclosed in U.S. Pat. No. 6,896,524 issued May 24, 2005, the disclosure of which is hereby incorporated herein by reference.

Referring now to FIGS. 1A through 1C, a low profile socket connector 10 will be described.

The low profile socket connector 10 has a connector body 12 having a terminal housing 14 with internally disposed terminal cavities 16 that extend through a terminal housing 14. Female electric terminals (not shown) attached to lead wires 18a, 18b are inserted into the rearward ends of the terminal cavities 16 and retained in the terminal cavities via terminal seats 16a in a conventional manner. Any suitable female terminals and lead wires may be used for this purpose.

The connector body 12 includes an annular shroud 20 that is integrally connected to a mid-portion of the terminal housing 14 by a perpendicular end wall 22. The shroud 20 and end wall 22 form a socket 24 for receiving a plug connector 60 that has male terminals that mate with the female terminals in terminal housing 14 when the plug connector is plugged into the socket 24. The connector body 12 has a connector lock indicated generally at 26 for retaining the plug connector in the socket 24. The connector lock 26 is incorporated into the shroud 20 of the connector body 12 so as to provide a low profile socket connector as described below.

Connector lock 26 comprises an arm or beam 30 that is formed out of a forward exterior wall portion 32 of the shroud 20 itself and a rearward exterior wall portion 34 of the shroud 20 that extends rearward of end wall 22. An arm 30 is formed by forward and rearward pairs of through-slots 36, 38, wherein the through-slots are symmetrically disposed on either side of the arm 30, and extend through the forward and rearward exterior wall portions 32 and 34. The forward pair of through-slots 36 extend through the forward portion 32 and a forward portion of the rearward portion 34 of the shroud 20, as best shown in FIG. 1A. The rearward pair of through-slots 38 extend through the aft portion of the rearward exterior wall portion 34.

Both pairs of through-slots 36 and 38 have longitudinal parts and transverse parts so that the two-pairs of through-slots 36 and 38 cooperatively form flexible straps 40 that connect arm 30 to the remainder of the exterior wall of the shroud 20, specifically, the rearward exterior wall portion 34.

The forward pair of through-slots 36 are preferably generally U-shaped so that there are second forward transverse parts that provide flexible straps 42 at the front end of the shroud 20. Flexible straps 42 provide a continuous front edge and anti-tangle feature for shroud 20 while allowing the front of arm 30 to bow outwardly to operate the connector lock as explained below. The rearward through slots 38 are generally L-shaped so that the aft end of arm 30 forms a depressible “pump handle”release lever 44 that is free of the extended rearward exterior wall portion 34 of shroud 20.

The arm 30 has a lock nib 46 that is located between the straps 40 and 42 in the longitudinal direction and extends inwardly into the socket 24. The arm 30 also has and a triangularly shaped fulcrum 48 that extends inwardly into a space behind the end wall 22 of the socket 24. The triangularly shaped fulcrum 48 slopes outwardly in the rearward direction. The end wall 22 at the inner end of the socket 24 has a window to facilitate molding lock nib 46 and triangularly shaped fulcrum 48 preferably also has a slot aligned with lock nib 46 longitudinally to further facilitate molding lock nib 46.

Connector body 12 has a triangularly shaped fulcrum support 52 that is connected to the end wall 22, which slopes inwardly in the rearward direction. The fulcrum support 52 is located beneath the fulcrum 48 with its high point substantially aligned with the high point of fulcrum 48 to facilitate depression of the release lever 44. The fulcrum support 52 may also have a slot to facilitate molding.

The low profile socket connector 10 mates with a plug connector 60 that includes a forward plug portion 62 that plugs into the socket 24 as shown in FIGS. 1B and 1C.

In operation, due to the flexibility of the lock arm 30 and the straps 40 and 42, the lock nib 46 snaps over a lock shoulder (not shown) of the plug connector 60 when the plug portion 62 of the plug connector 60 is plugged into socket 24. The lock nib 46 thus retains the plug portion 62 of the plug connector 60 in the socket 24. In order to disconnect the plug connector 60, the end of “pump handle” release lever 44 is depressed manually, which causes the fulcrum 48 to engage the fulcrum support 52 and bow the forward portion of lock arm 30 outwardly so that the lock nib 46 is moved out of engagement with the lock shoulder of the plug connector 60. The plug connector 60 is then pulled away from the low profile socket connector 10. Although, lock arm 30 is preferably connected to the remainder of the shroud 20 both at the front end and rearward portion of the shroud 20, the flexibility of lock arm 30 and straps 40 and 42 is sufficient to lift the lock nib 46 out of engagement with the lock shoulder of the plug connector 60.

While the exterior wall 32 of the shroud 20 is illustrated as being generally elliptical, the exterior wall can be another shape, such as round, square or rectangular. In essence, the height or profile of any shape of connector can be reduced to provide a low profile socket connector so long as the exterior wall of the shroud has a lock arm located in a portion of the exterior wall of the shroud itself.

As shown at FIGS. 1B and 1C, the rearward end 64 of the connector body 12 (opposite the socket 24 which is disposed at a forward end of the connector body) has a seal housing 66 having a seal cavity 68 into which a seal 70 is slid along a longitudinal direction (parallel to the wires 18a, 18b). A loose piece strain relief 72 is then snapped onto the seal housing 66 which serves to trap the seal 70 in the seal cavity 68 and further locates the wires 18a, 18b so as to relieve strain induced by movements of the wires exterior to the low profile socket connector 10.

What remains needed in the art is an elimination of the need for a loose part strain relief for socket connectors.

### SUMMARY OF THE INVENTION

The present invention is a socket connector having an integral strain relief and seal seat.

The socket connector according to the present invention has a connector body which includes, at a rearward end thereof, a strain relief member which is integrally connected with the connector body. The strain relief member is composed of a terminal housing, a strain relief, and a seal seat. The seal seat is characterized by a left sidewall, a right sidewall, a top wall, each of which being formed between the terminal housing and the strain relief, wherein a bottom opening opposite the top wall is provided. In this regard, the seal seat is further characterized by the terminal housing having a terminal housing wall which faces, in parallel relation, a strain relief wall of the strain relief. The strain relief is provided with strain relief openings aligned with the terminal cavities of the socket connector for locating wires passing out from the terminal cavities.

In operation, an elastomeric seal is inserted into the seal seat via the bottom opening, wherein the seal has, on opposing sides thereof, a peripheral rib for sealingly interfacing with, respectively, the terminal housing and strain relief walls. The seal has seal openings which align with the terminal cavities and the strain relief openings when seated in the seal seat. Next, terminals located at respective ends of wires are placed into the respective terminal cavities and seated at respective terminal seats of the socket connector by passing through respectively aligned strain relief and seal openings into the terminal cavity, wherein the terminal cavities commence at the terminal housing wall.

Accordingly, it is an object of the present invention to provide a socket connector having an integral seal seat and strain relief.

This and additional objects, features and advantages of the present invention will become clearer from the following specification of a preferred embodiment.

### BRIEF DESCRIPTION OF THE DRAWINGS

FIG. 1A is a partly sectional, perspective front view of a prior art socket connector.

FIG. 1B is a perspective rear view of a prior art socket connector shown in operation with a plug connector, wherein the strain relief has not yet been snappingly attached to a seal housing of the socket connector.

FIG. 1C is a perspective view of the prior art socket connector of FIG. 1B, wherein now the strain relief has been snappingly attached to the seal housing.

FIG. 2 is a perspective, rear view of a socket connector having an integral strain relief member according to the present invention, wherein the seal seat thereof is partly cut away.

FIG. 3 is a forward perspective view of a seal according to the present invention.

FIG. 4 is a rearward perspective view of the seal of FIG. 3.

FIG. 5 is a second perspective, rear view of the socket connector of FIG. 2, wherein the seal seat is visible.

FIG. 6 is a perspective, rear view of a second embodiment of the socket connector of FIG. 2, wherein now the seal of FIGS. 3 and 4 is absent bosses and anchor nibs.

FIG. 7 is a perspective, rear view of the socket connector as in FIG. 6, wherein now wires have been operatively inserted and seated into respective terminal cavities of the socket connector.

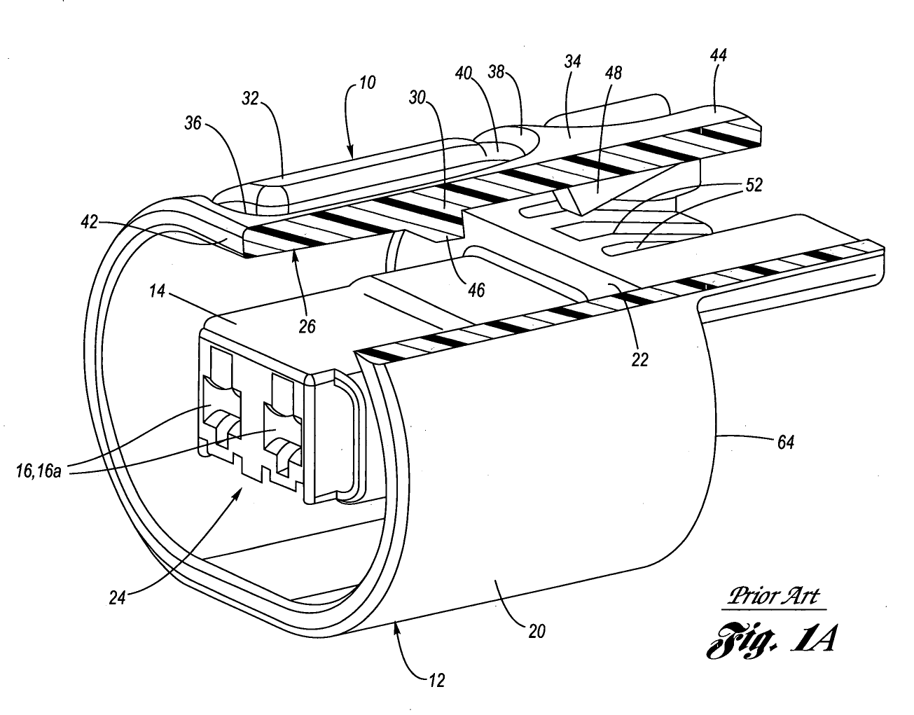

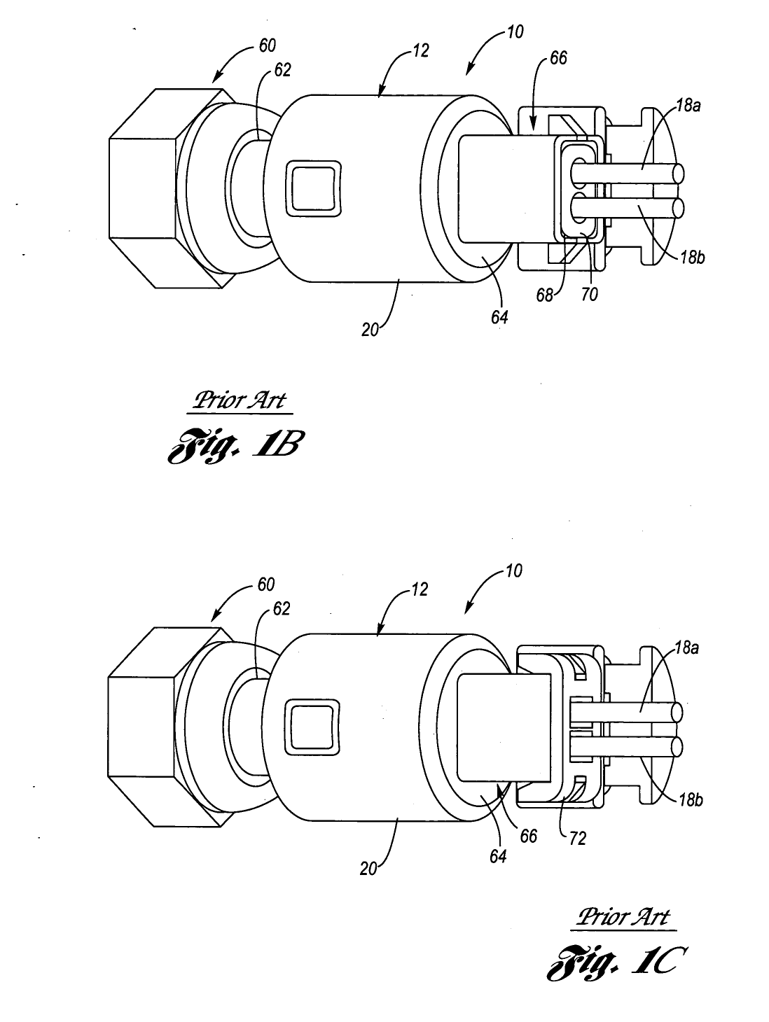

### DESCRIPTION OF THE PREFERRED EMBODIMENT

Referring now to the Drawing, FIGS. 2 through 7 depict various aspects of a socket connector 100, 100′ according to the present invention having a strain relief and seal seat integrally formed with the connector body thereof.

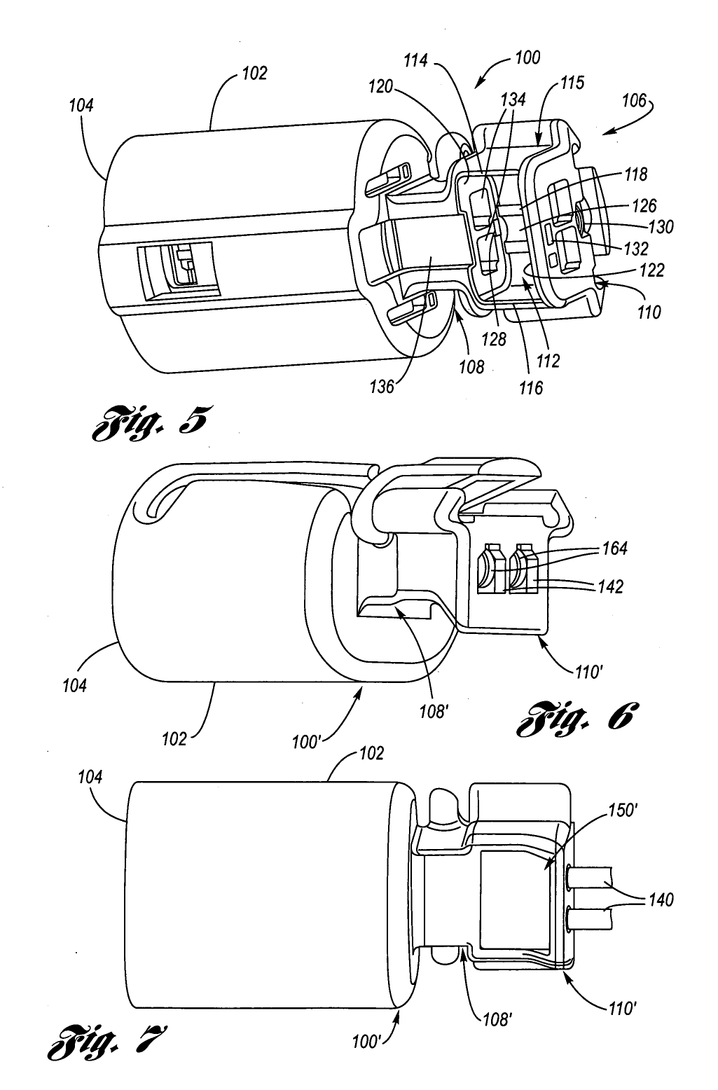

As shown at FIGS. 2 and 5, the socket connector 100, which is preferably, but not necessarily, of a low profile socket connector type as generally disclosed in above referenced U.S. Pat. No. 6,896,524, has a connector body 102 having a forward end 104 whereat is located a socket and terminal seats, as for example generally described in U.S. Pat. No. 6,896,524. The connector body 102 has a rearward end 105 disposed oppositely in relation to the forward end 104, wherein at the rearward end is located a strain relief member 106 which includes a terminal housing 108, a strain relief 110 and a seal seat 112, wherein the strain relief member 106 which is integrally connected with the connector body 102.

The seal seat 112 is defined by a seal seat shroud 115 composed of left and right sidewalls 114, 116 (shown at FIG. 5, but cut-away at FIG. 2) which extend between the terminal housing 108 and the strain relief 110, a top wall 118 which also extends between the terminal housing 108 and the strain relief 110, a terminal housing wall 120 which is oriented perpendicular to the left and right sidewalls and top wall, and a strain relief wall 122 which is oriented parallel to the terminal housing wall. The seal seat 112 has a bottom opening 124 disposed opposite in relation to the top wall 118 which extends between the terminal housing and the strain relief.

The top wall 118 has an optional concave notch 126 extending between the terminal housing and strain relief walls 120, 122. An optional first anchor hole 128 is provided in the terminal housing wall 120 adjoining the notch 126. An optional second anchor hole 130 is provided in the strain relief wall 122 adjoining the notch 126. An optional third anchor hole 132 is provided in the strain relief wall 122 adjacent the bottom opening 124. An optional slot 136 is provided in the terminal housing 108 adjacent the bottom opening 124.

The terminal housing 108 has at least one terminal cavity 134, commencing at the terminal housing wall 120, for receiving therein terminal provided wires 140 (see FIG. 7). The strain relief 110 and its associated strain relief wall 122 has at least one strain relief opening 142, one for each terminal cavity 134 and aligned respectively therewith.

In manufacture, the mold for the socket connector 100 includes a side core for providing the seal seat 112 within the seal seat shroud 115 which is oriented in perpendicular relation to one or more terminal cavity cores for providing the at least one terminal cavity 134.

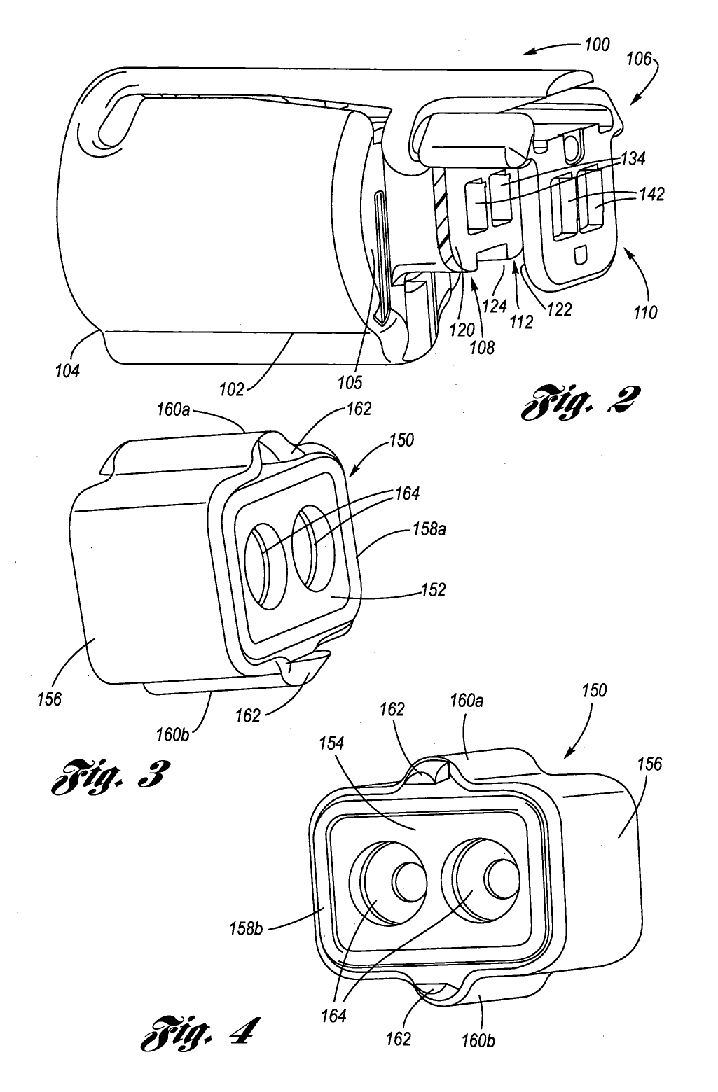

An elastomeric seal 150, shown at FIGS. 3 and 4, has a symmetric configuration, characterized by a front face 152, and opposite rear face 154 and a peripheral sidewall 156 extending therebetween. The front and rear faces 152, 154 each has a peripheral rib 158a, 158b. The peripheral sidewall 156 has an optional upper boss 158a and an oppositely disposed optional lower boss 158b. At each end of each of the upper an lower bosses 160a, 160b, respectively, is an optional anchor nib 162. At least one seal opening 164, one for each terminal cavity 134, extends between the front and rear faces 152, 154.

Operation of the socket connector 100 according to the present invention will be described.

The elastomeric seal 150 is inserted into the seal seat 112 via the bottom opening 124. In so doing, either the upper or lower boss 160a, 160b seats into the notch 126 of the top wall 118, and an anchor nib 162 is anchored, respectively, into the first, second and third anchor holes 128, 130, 132, and an anchor nib is located at the slot 128.

With the seal 150 seated in the seal seat 112 of the seal seat shroud 115, the one or more terminal cavities 134 are aligned, respectively with the one or more strain relief and seal openings 142, 164. Further, one of the front and rear faces is now sealingly disposed, via compression of the respective peripheral rib 158a, 158b, at the terminal housing wall 120, and less consequentially also at the strain relief wall 122 . Next, terminals located at respective ends of wires 140 are placed into the respective terminal cavities and seated at respective terminal seats of the socket connector by passing through respectively aligned strain relief and seal openings into the terminal cavity.

FIGS. 6 and 7 depict a socket connector 100′ in which the elastomeric seal 150′ has none of the aforementioned upper and lower bosses and anchor nibs. In this regard, the socket connector 100′ further has a terminal housing 108′ absent the aforementioned slot and a terminal housing wall absent the aforementioned first anchor hole; an upper wall absent the aforementioned notch; and a strain relief 110′ absent the aforementioned second and third anchor holes. In this embodiment, the seal 150′ is received into the seal seat through the bottom opening as described hereinabove, and the press-fit of the seal holds the seal seated in the seal seat.

To those skilled in the art to which this invention appertains, the above described preferred embodiment may be subject to change or modification. Such change or modification can be carried out without departing from the scope of the invention, which is intended to be limited only by the scope of the appended claims.

1. A socket connector, comprising:
a connector body having a forward end and a rearward end;
a terminal housing integrally connected to said rearward end of said connector body, said terminal housing having a terminal housing wall, at least one terminal cavity being formed in said terminal housing and said terminal housing wall; and
a seal seat shroud integrally connected to said terminal housing wherein said connector body, said terminal housing and said seal seat shroud are a single piece, said seal seat shroud comprising:
a shroud wall oriented parallel to said terminal housing wall, said shroud wall having at least one shroud opening, one shroud opening for each said terminal cavity, each shroud opening being aligned with a respective terminal cavity;
a left sidewall extending between said terminal housing wall and said shroud wall;
a right sidewall extending between said terminal housing wall and said shroud wall;
a top wall extending between said terminal housing wall and said shroud wall; and
a seal seat formed in said seal seat shroud between said terminal housing wall and said shroud wall;
wherein a bottom opening is formed in said seal seat shroud between said terminal housing wall and said shroud wall, said bottom opening being disposed opposite said top wall; and
a seal sealingly receivable into said seal seat through said bottom opening in a direction toward said top wall.

2. (canceled)

3. The socket connector of claim 1, wherein said seal comprises:
a front face;
a rear face disposed opposite said front face; and
a peripheral sidewall extending between said front and rear faces;
wherein at least one seal opening extends between said front and rear faces, one seal opening for each said terminal cavity.

4. The socket connector of claim 3, wherein said seal further comprises:
a single peripheral rib respectively disposed at each of said front and rear faces.

5. The socket connector of claim 4, further comprising means for retaining said seal in a seated position within said seal seat.

6. A socket connector, comprising:
a connector body having a forward end and a rearward end;
a terminal housing integrally connected to said rearward end of said connector body said terminal housing having a terminal housing wall, at least one terminal cavity being formed in said terminal housing and said terminal housing wall; and
a seal seat shroud integrally connected to said terminal housing wherein said connector body said terminal housing and said seal seat shroud are a single piece, said seal seat shroud comprising:
a shroud wall oriented parallel to said terminal housing wall, said shroud wall having at least one opening, one shroud opening for each said terminal cavity, each shroud opening being aligned with a respective terminal cavity;
a left sidewall extending between said terminal housing wall and said shroud wall;
a right sidewall extending between said terminal housing wall and said shroud wall;
a top wall extending between said terminal housing wall and said shroud wall; and
a seal seat formed in said seal seat shroud between said terminal housing wall and said shroud wall;
wherein a bottom opening is formed in said seal seat shroud between said terminal housing wall and said shroud wall, said bottom opening being disposed opposite said top wall;
a seal sealingly receivable into said seal seat through said bottom opening in a direction toward said top wall, wherein said seal comprises:
a front face;
a rear face disposed opposite said front face; and
a peripheral sidewall extending between said front and rear faces;
wherein at least one seal opening extends between said front and rear faces, one seal opening for each said terminal cavity; and
means for retaining said seal in a seated position within said seal seat.

7. (canceled)

8. The socket connector of claim 6, wherein said seal further comprises:
a single peripheral rib respectively disposed at each of said front and rear faces.

9. (canceled)
